(19) United States
(12) Patent Application Publication
(10) Pub. No.: US 2012/0249545 A1
(43) Pub. Date: Oct. 4, 2012

(54) USER INTERFACE APPARATUS FOR PROVIDING REPRESENTATION OF 3D THEME FOR COVER PAGE AND METHOD OF OPERATING THE SAME

(76) Inventor: Yoon-Soo KIM, Seongnam-si (KR)

(21) Appl. No.: 13/437,184

(22) Filed: Apr. 2, 2012

(30) Foreign Application Priority Data
Mar. 31, 2011 (KR) 10-2011-0029389

(51) Int. Cl. G06T 15/00

(52) U.S. Cl. 345/419

(57) ABSTRACT

A user interface apparatus and a method of operating the user interface apparatus are provided. The user interface apparatus includes a storage unit including a cover page storage unit. A library storage unit includes a 3D graphics library for supporting 2D/3D graphics. An input unit is integrated with a display unit. A kernel unit controls hardware devices and processes pieces of data. A user interface unit determines whether a page to be displayed is a cover page, and if it is determined that the page to be displayed is the cover page, renders the cover page theme data using the 3D graphics library, and displays rendered results. An OS processing unit controls the user interface unit so that the user interface unit accesses and uses the library storage unit, and so that the user interface unit inputs/outputs data to/from the hardware devices.

### CROSS REFERENCE

This application claims priority of Korean Patent Application No. 10-2011-0029389, filed 31 Mar. 2011 with the Korean Intellectual Property Office, where the entire contents are incorporated herein by reference.

### BACKGROUND OF THE INVENTION

1. Technical Field

The present invention relates, in general, to a user interface apparatus for a mobile communication terminal that is operated using a Linux-based operating system and, more particularly, to a user interface apparatus for providing a representation of a three-dimensional (3D) theme for a cover page, which provides a cover page that supports various theme functions capable of representing various graphic effects such as two-dimensional (2D) and 3D effects, and to a method of operating the user interface apparatus.

2. Description of the Related Art

With the rapid development of mobile communication technology, smart phones that are mobile communication terminals, in which mobile phone technology is combined with a Personal Digital Assistant (PDA) that is a kind of portable computer, have been rapidly popularized.

Typically, such a smart phone is provided with an Operating System (OS) and is configured to allow various application programs related to health, interest, learning, life, and utility to be installed on the OS, thus allowing users to utilize various functions. Operating systems for mobile communication terminals, which are typically installed on smart phones, include iPhone OS (iOS), Android, Symbian, Bada, and BlackBerry. Among these OSs, the OS that has been most widely used is the Android OS.

The important characteristic of the Android OS is that it is an open OS. Due to this characteristic, the Android OS does not include a User Interface (UI). That is, the UI must be installed on the Android OS as an application program. The UI installed on the OS in this way is typically referred to as a launcher.

FIG. 1 is a diagram showing the screen configuration of a smart phone using the execution of a typical Java-based launcher, which shows an example of a screen configuration when the number of pages is set to three.

Referring to FIG. 1, the Java-based launcher includes a plurality of pages 1. Movement between the pages 1 is performed in a direction corresponding to the direction of a gesture made by a user on a touch screen. The gesture refers to the user's action of continuously touching the touch screen with his or her finger or a touch pen in a specific shape.

Further, a screen area displayed by the launcher includes a fixed area (typically referred to as a ‘dock’ or a ‘dock bar’) in which application program icons are not changed even if pages are moved by the gesture. However, application program icons, arranged in an area other than the fixed area, are mapped to pages, and thus they are moved along with the movement of the pages.

Typically, the pages are implemented in 2D graphics because the launcher is a Java-based application program.

As described above, since the launcher, which is the typical user interface of a smart phone, is a Java-based application program, a problem arises in that graphics that can be represented on pages constituting the user interface screen of the smart phone are limited to 2D forms.

Therefore, there is a disadvantage in that it is impossible to add and represent various graphic effects on the user interface screen of the smart phone, thus causing the user to be easily bored with such a page screen.

### SUMMARY OF THE INVENTION

Accordingly, the present invention has been made keeping in mind the above problems occurring in the prior art, and an object of the present invention is to provide a user interface apparatus for providing the implementation of a 3D theme function for a cover page, which provides a cover page that supports various theme functions capable of representing various graphic effects such as 2D and 3D effects, and a method of operating the user interface apparatus.

In order to accomplish the above object, the present invention provides a user interface apparatus for providing a representation of a three-dimensional (3D) theme for a cover page, including a storage unit including a cover page storage unit for storing cover page theme data; a library storage unit including a 3D graphics library for supporting two-dimensional (2D) and 3D graphics; a display unit; an input unit integrated with the display unit and configured to output data about coordinates of a location pressed by a user; a kernel unit for controlling hardware devices including the storage unit, the display unit, and the input unit and processing pieces of data input/output to/from the respective hardware devices; a user interface unit for determining whether a page to be displayed on a screen of the display unit is a cover page, and if it is determined that the page to be displayed is the cover page, rendering the cover page theme data stored in the cover page storage unit using the 3D graphics library, and displaying rendered results on the display unit; and an Operating System (OS) processing unit for controlling the user interface unit so that the user interface unit accesses and uses the library storage unit, and so that the user interface unit accesses the hardware devices via the kernel unit and inputs/outputs data to/from the hardware devices.

Preferably, the storage unit may further include a normal page storage unit for storing normal page data, and the user interface unit comprises a normal page processing unit activated in response to predetermined control and configured to display the normal page data from the normal page storage unit on the display unit; a cover page processing unit activated under predetermined control and configured to render the cover page theme data stored in the cover page storage unit using the 3D graphics library and to display rendered results on the display unit; and a controller for activating the normal page processing unit or the cover page processing unit depending on whether a page to be displayed on a display screen in an initial operation stage is a cover page or a normal page, or whether a relevant page, reached after a page movement gesture has been generated via the input unit or after page movement has been controlled, is a cover page or a normal page.

Preferably, the 3D graphics library may be an Open Graphics Library for Embedded Systems (OpenGL|ES).

Preferably, the user interface apparatus may further include a theme storage unit for storing a plurality of pieces of theme data including 2D page data and 3D cover page theme data that can be implemented in a normal page and a cover page using various themes, wherein the user interface unit further comprises a theme change unit for displaying a theme list of pieces of theme data from the theme storage unit on the display unit when a theme change request has been generated via the input unit, and individually loading theme data corresponding to a selected theme and storing the theme data in the normal page storage unit and the cover page storage unit if any theme is selected from the theme list.

Preferably, the cover page may be located on a left of normal pages.

Further, in order to accomplish the above object, the present invention provides a method of operating a user interface apparatus for providing the implementation of a 3D theme function for a cover page, including a) operating, by an operating system processing unit, a user interface unit if an initial operation event is generated; b) loading, by the operated user interface unit, cover page theme data and normal page data; c) determining, by the user interface unit, whether a page to be displayed on a display unit is a cover page; d) rendering, by the user interface unit, the loaded cover page theme data using a 3D graphics library if it is determined that the page to be displayed on the display unit is a cover page; and e) displaying, by the user interface unit, rendered cover page theme data on the display unit.

Preferably, the method may further include f) displaying, by the user interface unit, the normal page data on the display unit if it is determined in c) that the page to be displayed is a normal page; g) checking, by the user interface unit, whether a gesture has been generated via an input unit during performance of f); h) determining, by the user interface unit, whether the gesture is a page movement gesture if the gesture has been generated in g); and i) determining whether a relevant page that is reached depending on the gesture and that is to be displayed on the display unit is a cover page if it is determined that the gesture is a page movement gesture, wherein if it is determined in i) that the relevant page that is reached is the cover page, d) and e) are performed.

Preferably, the method may further include j) activating, by the user interface unit, a theme change unit and respectively storing cover page theme data and normal page data, corresponding to a theme selected by the input unit from a plurality of themes stored in a theme storage unit, in a cover page storage unit and a normal page storage unit if a theme change request has been generated via the input unit, after j) has been performed, operations after b) are performed, and a cover page and a normal page corresponding to the changed theme are displayed.

Preferably, the cover page may be configured such that either any one of special effects such as switching, animation, fog, and masking, or a 3D object, is applied to the cover page using the 3D graphics library.

Preferably, the 3D graphics library may be an Open Graphics Library for Embedded Systems (OpenGL|ES).

Preferably, the cover page may be located on a left of normal pages.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the screen configuration of a smart phone using the execution of a typical Java-based launcher;

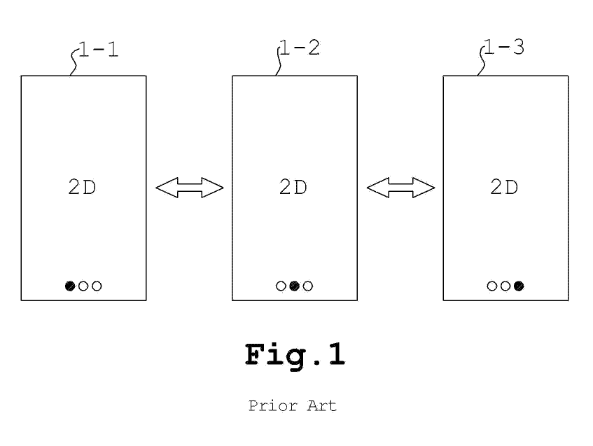

FIG. 2 is a diagram showing the configuration of a user interface apparatus for providing the implementation of a 3D theme function for a cover page according to the present invention;

FIG. 3 is a diagram showing the hierarchical structure of an operating system including a user interface for providing the implementation of a 3D theme function for a cover page according to the present invention;

FIG. 4A and 4B are diagrams showing the screen configuration of a smart phone using the operation of the user interface apparatus according to the present invention; and

FIG. 5 is a flowchart showing a method of operating the user interface apparatus for providing the implementation of a 3D theme function for a cover page according to the present invention.

### DESCRIPTION OF THE PREFERRED EMBODIMENTS

Hereinafter, the configuration of a user interface apparatus for providing the implementation of a 3D theme function for a cover page and a method of operating the user interface apparatus according to the present invention will be described in detail with reference to the attached drawings.

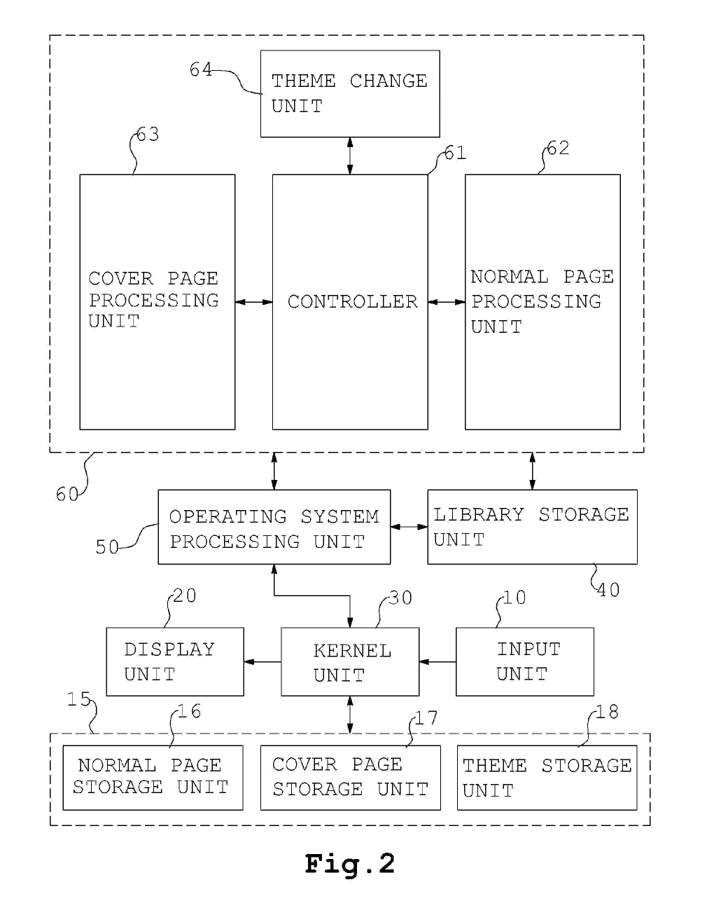

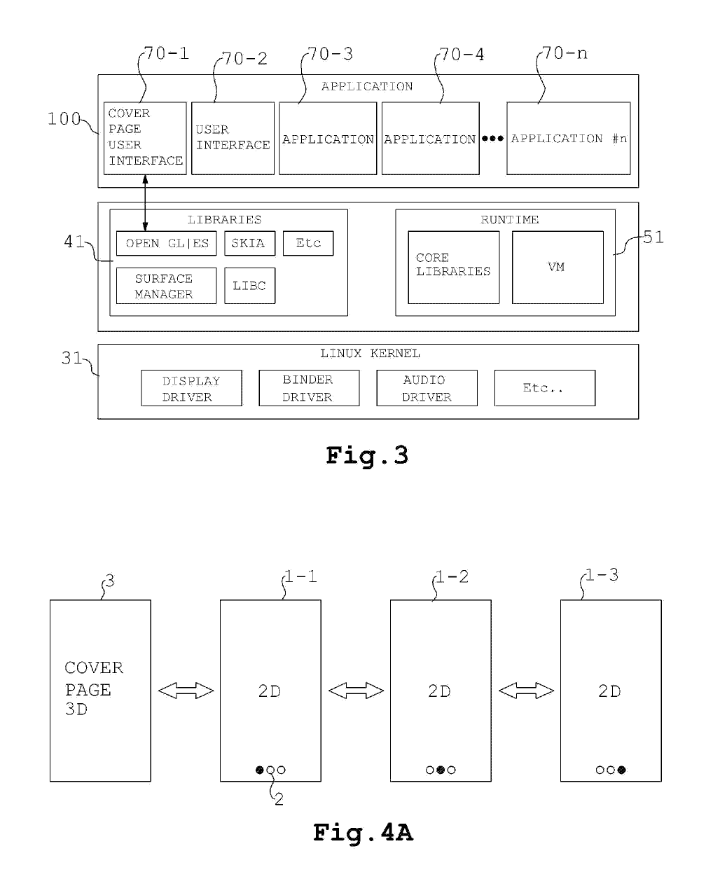

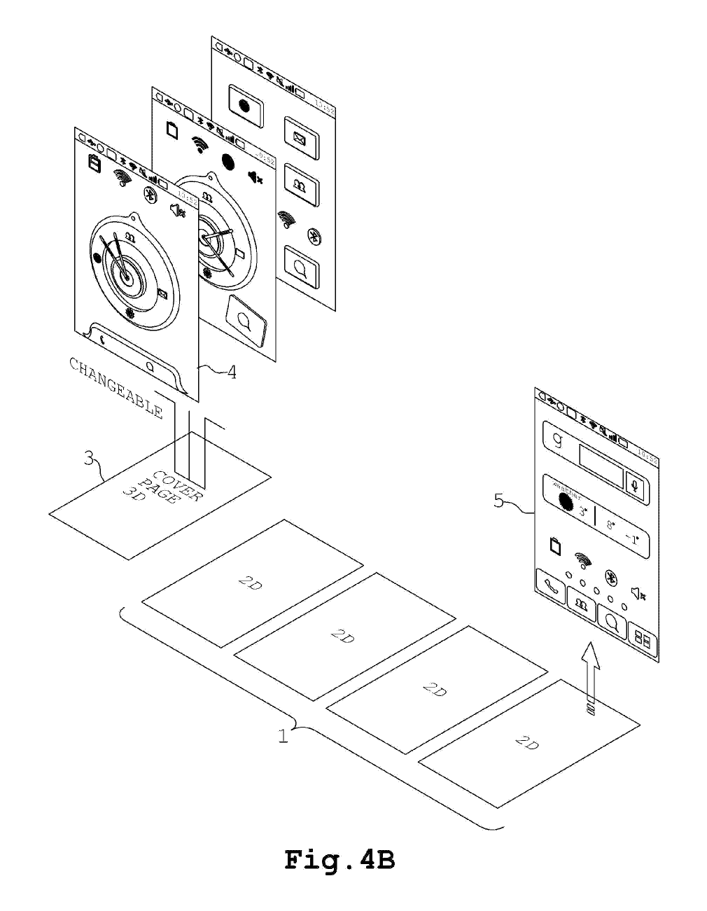

FIG. 2 is a diagram showing the configuration of a user interface apparatus for providing the implementation of a 3D theme function for a cover page according to the present invention, FIG. 3 is a diagram showing the hierarchical structure of an operating system including a user interface for providing the implementation of a 3D theme function for a cover page according to the present invention, and FIG. 4A and 4B are diagrams showing the screen configuration of a smart phone using the operation of the user interface apparatus according to the present invention, wherein FIG. 4A illustrates movement between pages according to the present invention and FIG. 4B illustrates an example of the application of various themes according to the present invention.

Referring to FIGS. 2 to 4A and 4B, the user interface apparatus according to the present invention includes an input unit 10 that is a hardware layer, a display unit 20, a storage unit 15, a kernel unit 30 that is a kernel layer 41, an Operating System (OS) processing unit 50 that is a runtime layer 51, a library storage unit 40 that is a library layer 41, and a user interface unit 60 that is an application layer 100.

The display unit 20 is implemented as a Liquid Crystal Display (LCD), and displays text and various graphics such as 2D and 3D graphics.

The input unit 10 is integrated with the display unit 20 and is configured to output data about the coordinates of a location which is touched with the user's finger or a touch pen.

The storage unit 15 stores various pieces of information for the user interface, and includes a normal page storage unit 16 for storing normal page data, a cover page storage unit 17 for storing cover page theme data, and a theme storage unit 18 for storing pieces of theme data including pieces of cover page theme data and pieces of normal page data related to a plurality of themes, as shown in FIG. 4B. The theme data stored in the theme storage unit 18 may further include information about graphic effects (special effect information such as switching, animation, fog, and masking, 3D objects, etc.) mapped to the cover page theme data. Further, when cover page theme data corresponding to a specific theme is stored in the cover page storage unit 17, the graphic effect information must be stored together with the stored cover page theme data with the graphic effect information mapped to the cover page theme data.

As shown in FIG. 3, the kernel unit 30 is formed on a Linux kernel layer 31 and is provided with respective drivers for controlling hardware devices such as the display unit 20, the input unit 10, and the storage unit 15. The kernel unit 30 allows the OS processing unit and the user interface unit 60 to control the hardware devices and input or output data to or from relevant hardware devices.

The hardware layer may further include a power supply unit, a keypad, wireless communication units for Wireless Fidelity (WiFi), Code Division Multiple Access (CDMA), and Bluetooth, a camera, etc., in addition to the display unit 20, the input unit 10, and the storage unit 15. The kernel unit 30 may include respective drivers for controlling the corresponding hardware devices.

The library storage unit 40 stores a plurality of libraries such as an Open Graphics Library for Embedded Systems (OpenGL|ES), Skia, Surface Manage, a Source Graphics Library (SGL), and a Secure Socket Layer (SSL) library, which allow the user interface to be more conveniently and usefully used. In particular, OpenGL|ES, which is used when a cover page having a theme is configured according to the present invention, is a standard for 3D graphic acceleration, and provides a cross-platform Application Programming Interface (API) for 2D/3D functionality on an embedded system including vehicles, various types of facilities, and portable devices.

The OS processing unit 50 allows the user interface unit 60 to utilize the libraries stored in the library storage unit 40, and to control the hardware devices and input or output data to or from the hardware devices via the kernel unit 30.

The user interface unit 60 is implemented on the application layer 100, and provides a medium for allowing the user to control various functions of the smart phone and showing the results of the control, that is, a medium for allowing the user and the smart phone to communicate with each other. In detail, the user interface unit 60 divides the structure of a screen, which was conventionally implemented using only normal pages, into a cover page and normal pages, and then configures the screen. If a page to be displayed on the display unit 20 is a cover page, the user interface unit 60 renders the cover page theme data stored in the cover page storage unit 17 depending on graphic effect information mapped to the cover page theme data by using the OpenGL|ES stored in the library storage unit 40 via the OS processing unit 50, and then displays the rendered results on the display unit 20. Since the cover page is rendered using OpenGL|ES, graphics in which special effects such as switching, animation, fog, and masking, 3D objects, etc. are used are applied to the cover page. In contrast, typical 2D graphics in which themes according to the present invention are used are applied to the normal pages. It is preferable that the user interface unit 60 according to the present invention be written in a C-based language, such as C or C++.

In detail, the user interface unit 60 includes a controller 61, a normal page processing unit 62, a cover page processing unit 63, and a theme change unit 64.

The controller 61 determines whether a page to be displayed on a display screen in an initial operation stage is a cover page or a normal page, and activates the normal page processing unit 62 or the cover page processing unit 63 on the basis of the result of the determination. Further, if a page movement gesture has been generated via the input unit, the controller 61 performs page movement and then activates the normal page processing unit 62 or the cover page processing unit 63 depending on whether a relevant page reached through the page movement is a cover page or a normal page. That is, the term “initial operation stage” means a stage in which the user interface is initially operated when the smart phone is powered on and when the user interface, that is, the launcher, is changed.

The normal page processing unit 62 is activated in response to the control of the controller 61 and displays the normal page data stored in the normal page storage unit 16 on the display unit 20. Further, the normal page processing unit 62 receives a gesture of continuous input of pieces of coordinate data output from the input unit via the OS processing unit 50 and the controller 61, as shown in FIG. 4A, and moves to a normal page displayed on the screen of the display unit 20 corresponding to the input gesture. For example, in FIG. 4A, when a currently displayed page is a second normal page 1-2, and a right movement gesture is input, data about a third normal page 1-3 is read from the normal page storage unit 16 and is then displayed on the display unit 20. If a left movement gesture is generated in the state in which a first normal page 1-1 is displayed on the screen of the display unit 20, the controller 61 will activate the cover page processing unit 63. That is, the controller 61 must know whether the page currently displayed on the screen of the display unit 20 is a cover page or a normal page, and also know even the location, that is, the page number, of a relevant normal page if the currently displayed page is the normal page.

The cover page processing unit 63 is activated in response to the control of the controller 61 and is configured to render the cover page theme data stored in the cover page storage unit 17 by using OpenGL|ES that is a 3D graphics library depending on graphic effect information mapped to the cover page theme data and then display the rendered results on the display unit 20.

The theme change unit 64 is activated in response to the control of the controller 61 when a theme change request is generated via the input unit 10. The activated theme change unit 64 displays a theme list of multiple themes stored in the theme storage unit 18 on the display unit 20. When one of the themes in the displayed theme list is selected, the theme change unit 64 stores cover page theme data, corresponding to the selected theme, in the cover page storage unit 17. Further, when the selected theme is also applied even to a normal page, the theme change unit 64 stores normal page data corresponding to the theme in the normal page storage unit 16. After the theme has been changed in this way, the theme change unit 64 returns the right of control to the controller 61. The controller 61 that received back the right of control determines the page displayed on the screen of the display unit 20 and selectively activates the cover page processing unit 63 or the normal page processing unit 62 corresponding to the page, thus enabling the changed theme to be applied to the page. As shown in FIG. 4B, the theme change unit 64 applies various themes, in which various graphic effects are used, to the cover page.

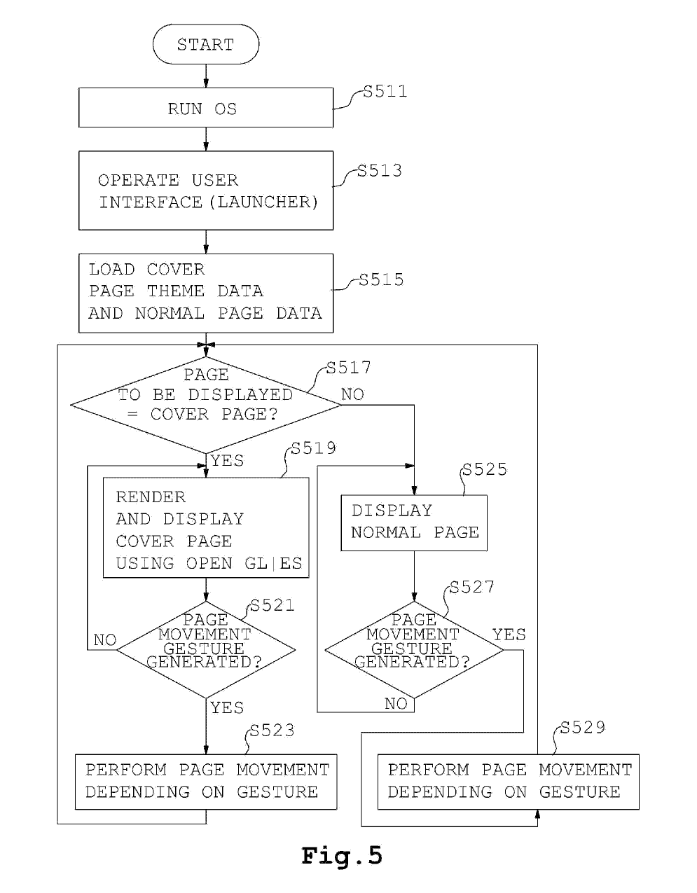

FIG. 5 is a flowchart showing a method of operating the user interface apparatus for providing the implementation of a 3D theme function for a cover page according to the present invention.

Referring to FIG. 5, when power is supplied to the smart phone, the OS processing unit 50 runs at step S511, and the user interface unit 60 is operated at step S513.

The operated user interface unit 60 checks a set theme, and stores cover page theme data corresponding to the relevant theme in the cover page storage unit 17 and also stores normal page data corresponding to the theme in the normal page storage unit 16 via the OS processing unit 50 and the kernel unit 30 at step S515. In this case, the normal page storage unit 16 stores pieces of normal page data about all configured normal pages. For example, when three normal pages are configured, as shown in FIG. 4A, the normal page storage unit 16 stores pieces of normal page data about a first normal page 1-1, a second normal page 1-2, and a third normal page 1-3, respectively.

When the page data is loaded, the user interface unit 60 determines whether a page to be displayed on the display unit 20 is a cover page at step S517. For this, the user interface unit 60 must know whether the page to be displayed on the display unit 20 is a cover page 3, or know the page number of a normal page 1 if the page to be displayed is the normal page 1.

If it is determined that the page to be displayed on the display unit 20 is a cover page, the user interface unit 60 renders cover page theme data stored in the cover page storage unit 17 depending on graphic effect information (special effect information such as switching, animation, fog, and masking, or 3D object information) by using OpenGL|ES, which is a 3D graphics library stored in the library storage unit 40, via the OS processing unit 50, and then displays the rendered results on the display unit 20 at step S519.

If the cover page is displayed, the user interface unit 60 checks whether a page movement gesture has been generated via the input unit 10 at step S521.

In this case, if the page movement gesture has been generated, the user interface unit 60 performs page movement depending on the gesture at step S523, and returns to step S517 to determine whether a page to be displayed is a cover page or a normal page.

If it is continuously determined that the page to be displayed is a cover page, the user interface unit 60 will repeat the above-described steps S519 to S523.

In contrast, if the page to be displayed is a normal page, the user interface unit 60 displays the normal page stored in the normal page storage unit 16 on the display unit 20 at step S525.

After the normal page has been displayed, the user interface unit 60 checks whether a page movement gesture has been generated via the input unit 10 in the state of the normal page being displayed at step S527. If the page movement gesture has been generated, the user interface unit 60 performs page movement depending on the gesture at step S529, and then repeatedly performs a procedure after the above-described step S517.

As described above, the present invention is advantageous in that existing normal pages are represented by 2D graphics, and a separately configured cover page may be represented by graphics, to which various graphic effects having various themes and including 3D graphics are applied, using OpenGL|ES that has been configured and used on the library layer of an OS, so that a user's satisfaction can be improved from the standpoint of the user, and the sales of smart phones can be increased thanks to the improvement of the user's satisfaction from the standpoint of a provider that provides smart phones.

Further, the present invention is also advantageous in that the theme of a cover page having various graphic effects can be changed, thus providing the publicity themes of businesses through the cover page. Therefore, the present invention is advantageous in that the theme of the cover page can be freely changed at low cost from the standpoint of a user, and theme producers/requesters can efficiently publicize businesses and products at low cost thanks to the themes.

Meanwhile, those skilled in the art will appreciate that the present invention is not limited to the above-described embodiments, and that various improvements, modifications, additions and substitutions are possible, without departing from the gist of the invention. It should be understood that as long as the implementation of improvements, modifications, additions and substitutions falls within the scope of the accompanying claims, the spirit thereof belongs to the scope of the present invention.

What is claimed is:

1. A user interface apparatus for providing a representation of a three-dimensional (3D) theme for a cover page, comprising:
a storage unit including a cover page storage unit for storing cover page theme data;
a library storage unit including a 3D graphics library for supporting two-dimensional (2D) and 3D graphics;
a display unit;
an input unit integrated with the display unit and configured to output data about coordinates of a location pressed by a user;
a kernel unit for controlling hardware devices including the storage unit, the display unit, and the input unit and processing pieces of data input/output to/from the respective hardware devices;
a user interface unit for determining whether a page to be displayed on a screen of the display unit is a cover page, and if it is determined that the page to be displayed is the cover page, rendering the cover page theme data stored in the cover page storage unit using the 3D graphics library, and displaying rendered results on the display unit; and
an Operating System (OS) processing unit for controlling the user interface unit so that the user interface unit accesses and uses the library storage unit, and so that the user interface unit accesses the hardware devices via the kernel unit and inputs/outputs data to/from the hardware devices.

2. The user interface apparatus according to claim 1, wherein:
the storage unit further comprises a normal page storage unit for storing normal page data, and
the user interface unit comprises:
a normal page processing unit activated in response to predetermined control and configured to display the normal page data from the normal page storage unit on the display unit;
a cover page processing unit activated under predetermined control and configured to render the cover page theme data stored in the cover page storage unit using the 3D graphics library and to display rendered results on the display unit; and
a controller for activating the normal page processing unit or the cover page processing unit depending on whether a page to be displayed on a display screen in an initial operation stage is a cover page or a normal page, or whether a relevant page, reached after a page movement gesture has been generated via the input unit or after page movement has been controlled, is a cover page or a normal page.

3. The user interface apparatus according to claim 1, wherein the 3D graphics library is an Open Graphics Library for Embedded Systems (OpenGL|ES).

4. The user interface apparatus according to claim 1, further comprising a theme storage unit for storing a plurality of pieces of theme data including 2D page data and 3D cover page theme data that can be implemented in a normal page and a cover page using various themes,
wherein the user interface unit further comprises a theme change unit for displaying a theme list of pieces of theme data from the theme storage unit on the display unit when a theme change request has been generated via the input unit, and individually loading theme data corresponding to a selected theme and storing the theme data in the normal page storage unit and the cover page storage unit if any theme is selected from the theme list.

5. The user interface apparatus according to claim 1, wherein the cover page is located on a left of normal pages.

6. A method of operating a user interface apparatus for providing a representation of a three-dimensional (3D) theme for a cover page, comprising:
a) operating, by an operating system processing unit, a user interface unit if an initial operation event is generated;
b) loading, by the operated user interface unit, cover page theme data and normal page data;
c) determining, by the user interface unit, whether a page to be displayed on a display unit is a cover page;
d) rendering, by the user interface unit, the loaded cover page theme data using a 3D graphics library if it is determined that the page to be displayed on the display unit is a cover page; and
e) displaying, by the user interface unit, rendered cover page theme data on the display unit.

7. The method according to claim 6, further comprising:
f) displaying, by the user interface unit, the normal page data on the display unit if it is determined in c) that the page to be displayed is a normal page;
g) checking, by the user interface unit, whether a gesture has been generated via an input unit during performance of f);
h) determining, by the user interface unit, whether the gesture is a page movement gesture if the gesture has been generated in g); and
i) determining whether a relevant page that is reached depending on the gesture and that is to be displayed on the display unit is a cover page if it is determined that the gesture is a page movement gesture,
wherein if it is determined in i) that the relevant page that is reached is the cover page, d) and e) are performed.

8. The method according to claim 6, further comprising:
j) activating, by the user interface unit, a theme change unit and respectively storing cover page theme data and normal page data, corresponding to a theme selected by the input unit from a plurality of themes stored in a theme storage unit, in a cover page storage unit and a normal page storage unit if a theme change request has been generated via the input unit,
after j) has been performed, operations after b) are performed, and a cover page and a normal page corresponding to the changed theme are displayed.

9. The method according to claim 6, wherein the cover page is configured such that either any one of special effects such as switching, animation, fog, and masking, or a 3D object, is applied to the cover page using the 3D graphics library.

10. The method according to claim 6, wherein the 3D graphics library is an Open Graphics Library for Embedded Systems (OpenGL|ES).

11. The method according to claim 6, wherein the cover page is located on a left of normal pages.
